(19) United States
(12) Patent Application Publication
(10) Pub. No.: US 2003/0205175 A1
(43) Pub. Date: Nov. 6, 2003

(54) Method and apparatus for using metallurgical slag in cement clinker production

(76) Inventors: Charles T. Wiedenhoft, Overland Park, KS (US); Hans E. Steuch, Portland, OR (US)

Correspondence Address: WM. BRUCE DAY, MARTIN, PRINGLE, OLIVER, WALLACE & BAUER, LLP, 6900 COLLEGE BLVD.; SUITE 710, OVERLAND PARK, KS, 66211, US

(21) Appl. No.: 10/136,984

(22) Filed: May 2, 2002

(51) Int. Cl. C04B 2/10; F27B 7/00

(52) U.S. Cl. 106/739; 106/767; 432/106

(57) ABSTRACT

A method and apparatus for production of cement clinker uses fragmented metallurgical slag, such as from blast furnace production of iron or steel, introduced into a rotary kiln at an infeed located between the kiln front feed end and the rear outlet end. The metallurgical slag combines with predominantly limestone feedstock material flowing inwardly from the feed end toward a burner pipe at the outlet end and intimately blends with the limestone material to become transformed into cement clinker as the blended materials progress through the kiln. Preferably, the metallurgical slag is introduced into the kiln through a kiln dust infeed apparatus present in many rotary kilns at a mid location.

### FIELD OF THE INVENTION

This invention relates to manufacture of cement clinker and in particular to the use of metallurgical slag in the production of cement clinker.

### BACKGROUND OF THE INVENTION

Well prior to the 1982 issuance of Kogan, U.S. Pat. No. 4,342,598, it has been known to use slag from production of iron and steel as a raw material supplement for the production of cement clinker. Kogan signaled an advance in the use of iron and steel slag in the production of the cement clinker by identifying a preferred particle size of metallurgical slag, such as iron or steel slag, of 0.5 to 0.40 mm. Referring to still older art, Kogan disclosed that metallurgical slag was historically known to be a cheap and well calcined material beneficial in the production of cement clinker. The Kogan '598 patent proposed feeding iron and steel slag into a riser apparatus leading into a front or infeed end of a kiln wherein hot combustion gases would fracture the metallurgical slag by the rapid flash expansion and evaporation of moisture contained within the slag. The slag particles, now smaller in size, are mixed with decarbonized material recirculated from the kiln. The resulting mixture of the decarbonized material with the fractured slag flows down a chute and back into the infeed end of the kiln. Following the publication of Kogan, U.S. manufacturers developed additional methods of using iron and steel slag derived from metallurgical production in the production of the cement clinker. U.S. Pat. Nos. 5,421,880 and 5,494,515 to Young of Texas Industries, Inc., disclosed feeding blast furnace slag into a kiln to supplement the raw materials of clinker production. The blast furnace slag disclosed by Young was fed directly into the feed end of the kiln and was regulated in particle size by a different process than that disclosed by Kogan '598. The Young '515 and '880 patents disclosed a process by which the blast furnace slag was fed into the infeed end of a kiln after first being crushed and then size regulated by screening so as to obtain particles with the predominant size up to a maximum diameter of substantially 2 inches.

### OBJECTS OF THE INVENTION

The objects of the present invention are:

a) to provide a method of using metallurgical slag in the production of cement clinker;

b) to provide such a method of using slag by introducing it into a kiln at an optimal location in the kiln.

c) to provide such a method of using slag which enables environmentally and economically sound use of the slag; and

d) to provide such a method of using slag which applicant believes is optimal and best suited to the intended purpose.

Other objects and advantages of the present invention will become apparent from the following description taken in connection with the drawings.

### SUMMARY OF THE INVENTION

Applicant has developed an improved process for the use of metallurgical slags, such as slags from iron and steel production, which uses fragmented slag in the size range of 2 inches or less and which is fed into a rotary kiln at a mid kiln entry, such as through a dust scoop assembly provided in many kilns for recirculation of cement kiln dust (CKD).

### DESCRIPTION OF THE DRAWINGS

FIG. 1 is a generally diagrammatic view and layout of a rotary kiln plant with an arrangement embodying the present invention.

FIG. 2 is a detailed elevational view of a mid kiln infeed used in the present invention.

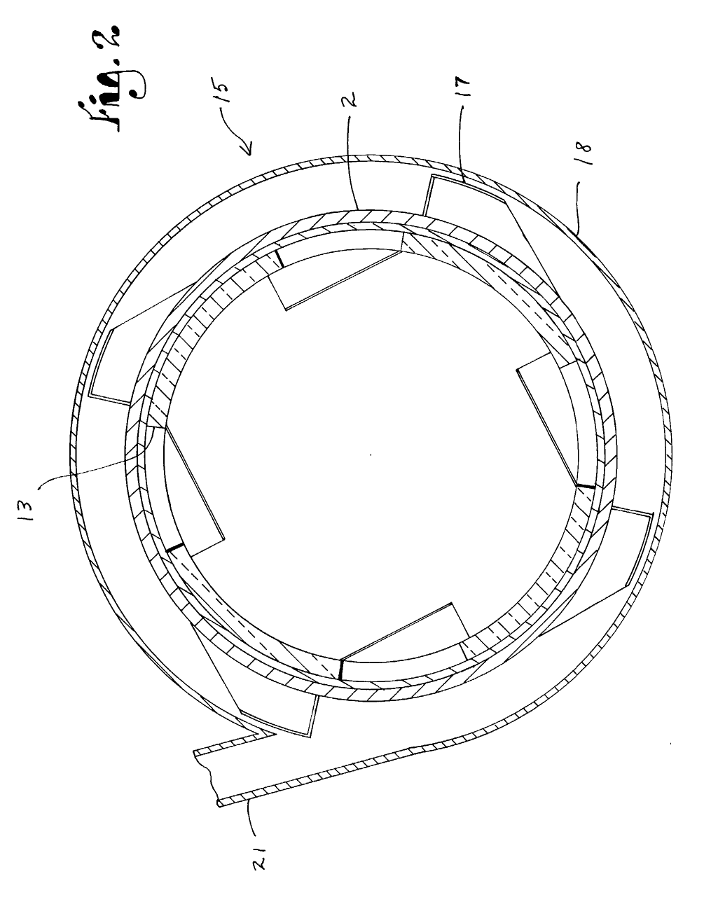

### DESCRIPTION OF THE PREFERRED AND ALTERNATE EMBODIMENTS

As required, a detailed description of the preferred embodiment is disclosed herein, however, other embodiments or configurations may be apparent based upon the following description to those having ordinary skill in the art.

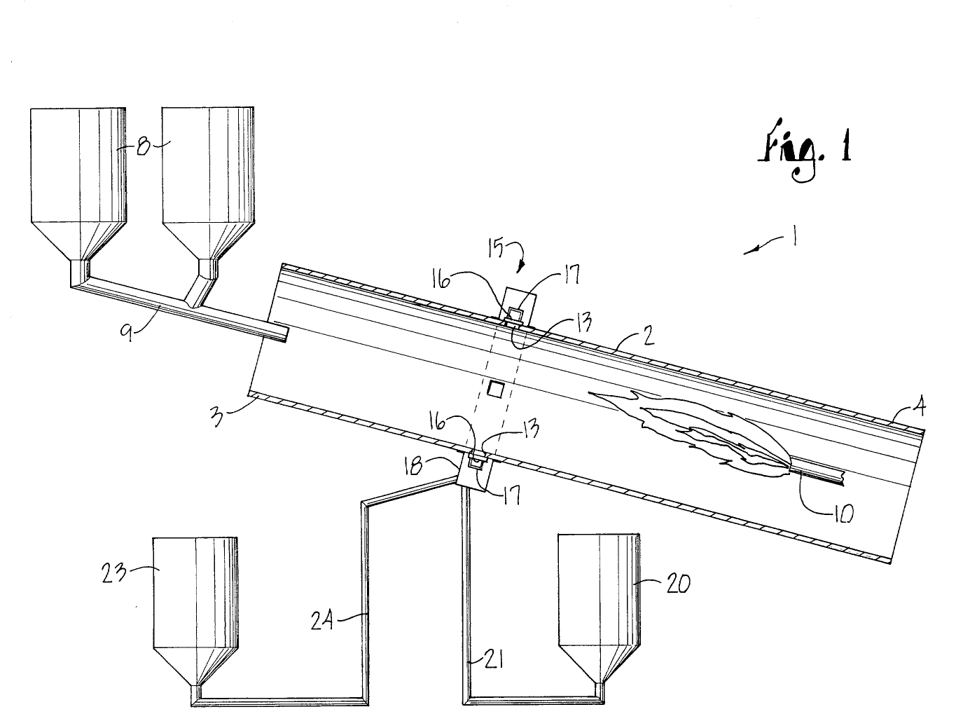

The reference 1, FIG. 1, generally designates a cement clinker production plant embodying the present invention. The production plant 1 includes an elongated rotary kiln 2 which is inclined downwardly and includes a front infeed end 3 and a lower rear outlet end 4 so that material flows downwardly toward the outlet end. The rotary kiln 2 is appropriately erected on supports (not shown) and caused to slowly rotate upon its longitudinal axis in order to advance feedstock materials fed in the kiln from one end to the other. The rotary kiln 2 is used for the production of cement clinker which falls from the kiln 2 at the rear outlet end 4 into a clinker cooler (not shown) where heat is recuperated as the clinker cools. Feedstock material necessary to cement clinker production is maintained in storage vessels 8 located adjacent the infeed end 3 and fed into the kiln 2 through inlet ducts 9. This material generally consists of ground limestone as a source of carbonates and argillaceous materials such as clay, shale, sand and iron ore. Proportions and specific constituents of raw materials for Portland cement are well known in the art. Additionally, some cement manufacturers use proprietary formulae for non-typical cement applications. Specific formulae are not necessary to the present invention.

The rotary kiln 2 includes a heat source 10 which is normally a coal fired burner pipe arrangement. The heat source 10 preferably produces temperatures within the kiln in the rage of 2500 to 3000 degrees Fahrenheit, sufficient for calcining the feedstock materials and reacting them to produce cement clinker. Cement clinker are the rounded, reacted agglomerations of calcined material which is then finely ground with small amounts of gypsum as a source of sulfates to make Portland cement. The cement powder is then mixed with water, sand and aggregate to make hydraulic concrete.

Intermediate of the front infeed end 3 and the rear outlet end 4 is a secondary infeed 13 which in the illustrated example, is used for the introduction of secondary feedstock materials or other materials which can be used in the production of cement clinker without disadvantage. In the illustrated example, at the secondary infeed is a dust scoop mechanism 15 consisting of a rotationally driven ring 16 carrying a plurality of scoops 17 which dump materials fed into a ring housing 18.

Heretofore, the dust scoop mechanism 15 has been used solely for the reentry of kiln dust into the kiln 2. Kiln dust is collected from the kiln gases before these are exhausted to atmosphere (not shown). Collected dust is fed to a kiln dust hopper 20 and returns via ducting 21 to the ring housing 18, wherein the dust is picked up and carried by the scoops 17 and dumped through ports leading directly into the kiln 2 so that as much dust as possible is reused in the production of cement clinker. The mid positioned infeed ports are positioned with respect to the length of the kiln so that there is sufficient residence time of the CKD and slag in the kiln for proper mixing with the feedstock material entering at the front infeed end 3 and so as to reach a proper calcining temperature. Rotary kilns usually include an interior chain section to promote mixing and add mass for temperature retention. The infeed ports are usually, if not always, located right below the end of the chain section so they do not become damaged by the chains and so there is sufficient residence time for the introduced dust to become heated to kiln reaction temperature.

The invention described herein utilizes the secondary infeed with the dust scoop mechanism, which has long been used, and in addition to returning kiln dust into the mid portion of the kiln 2 through the dust scoop mechanism 15, also infeeds metallurgical slag as an advantageous component for the production of cement clinker. In this system, metallurgical slag is fed from a hopper 23 through ducting 24 and is also dumped into the dust scoop mechanism ring housing 18 wherein it is mixed with any incoming kiln dust, picked up in the scoops 17 and dumped into the kiln 2 through secondary infeed ports. Preferably, the metallurgical slag is sufficiently fractured or broken to approximately 2 inch maximum size so that it is suitable for handling in and through the hopper 23, through the ducting 24 and through the dust scoop mechanism 15, and is sufficiently small to react fully with other materials within the kiln. Metallurgical slag is a by-product of metal ore furnace operation, particularly steel or iron blast furnace or electric furnace operation, and is a well calcined crust which forms on top of crucibles containing molten metal, such as iron or steel. This crust is predominantly formed of carbonates with lesser amounts of other constituents which can be used advantageously in the production of cement clinker. Further, use of the slag in cement production provides a way to dispose of the slag which heretofore has usually been deposited in unsightly piles as waste. The slag material is drawn off the furnace crucible and forms blocks or sheets upon cooling which are readily fractured by purposefully rough handling during transport or by running the material through crusher rollers, beater bars or other means which fracture the cooled slag into pieces of appropriate size such as 2 inch fragments for storage in the hopper 20 and conveyance through the ducting 21. The slag material need not be finely ground but instead may remain chunky or pebble sized. Upon entering the rotary kiln 2, the rapid heat rise of the material upon entering the kiln causes any moisture in the slag to flash off and cause further fracturing, Additionally, the chemical reactions taking place in the kiln consumes the individual slag particles while clinker are formed. Therefore, no fine grinding, pulverizing or comminution of the slag is required. Because particle size is only significant to slag transport and to completion of reaction in the kiln, there is no need to require the maximum size of the slag particles to be less than the approximately 2 inch fragments and no need to screen the slag particles or use other means of size determination.

Use of the slag fed into the kiln at the intermediate feed point, such as through the mid positioned dust scoops provides substantial energy savings to the kiln operator, as the slag is well calcined and rich in the carbonate constituents necessary for clinker production. Additionally, the slag material is obtained at no or low purchase cost, as it is considered a waste product from the metal smelter and furnace industry. Recycling of the slag provides a use for the slag rather than dumping into slag piles.

While the invention has been described and preferred embodiments have been disclosed, it is not to be limited thereto except as set forth in the following claims.

What is claimed and desired to be secured by Letters Patent is:

1. A method of producing cement clinker using an elongated rotary kiln having a feed end and a downwardly tilted outlet end with a heater situated generally adjacent the outlet end, the method comprising the steps of:
a) directing heat from the heater through the kiln and generally toward the feed end;
b) introducing a stream of primary cement feedstock material into the kiln at the feed end so that the cement feedstock material travels toward the heater and the outlet end while becoming calcined and heated to clinker-producing temperatures; and
c) introducing a secondary feedstock of fragmentary metallurgical slag into the kiln at a location downstream of said feed end and sufficiently upstream from said heater to provide a sufficient dwell time so that the metallurgical slag and the limestone feedstock become intimately blended, calcined and reacted into cement clinker as they progress through the kiln.

2. The method set forth in claim 1 including the step of introducing the secondary feedstock of fragmentary metallurgical slag into the kiln through kiln dust infeed ports.

3. An apparatus for producing cement clinker from cement feedstock and metallurgical slag comprising:
a) an elongate, rotary kiln tilted downwardly so that material fed therein flows downwardly from a feed end to an outlet end;
b) a heater device mounted in said kiln proximate to said outlet end and directing heat toward said feed end;
c) a primary feed apparatus for introducing a stream of cement feedstock material into the kiln at said feed end so that the cement feedstock flows toward the heater and the outlet end while becoming heated to calcined temperature; and
d) a secondary feed apparatus for introducing a secondary feedstock of fragmentary metallurgical slag into the kiln at a position downstream of said feed end and sufficiently upstream from said heater with a sufficient dwell time so that the metallurgical slag and cement feedstock becomes intimately blended and calcined into cement clinker as they progress through the kiln.

4. The apparatus set forth in claim 3 wherein said secondary feedstock is introduced into said kiln through kiln dust infeed ports.
